(19) United States
(12) Patent Application Publication
(10) Pub. No.: US 2009/0127233 A1
(43) Pub. Date: May 21, 2009

(54) LASER BEAM MACHINING APPARATUS

(75) Inventors: Kenji Asano, Ota-Ku (JP); Hiroshi Morikazu, Ota-ku (JP); Kunimitsu Takahashi, Ota-Ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/263,310

(22) Filed: Oct. 31, 2008

(30) Foreign Application Priority Data
Nov. 21, 2007 (JP) 2007-301270

(51) Int. Cl. B23K 26/00

(52) U.S. Cl. 219/121.7

(57) ABSTRACT

A laser beam machining apparatus including a chuck table for holding a wafer, and a laser beam irradiation unit for irradiating the wafer held on the chuck table with a pulsed laser beam. The laser beam machining apparatus further includes a plasma detecting part which includes a plasma receiving part for receiving a plasma generated by irradiation of the work with the laser beam radiated from the laser beam irradiation unit, and a spectrum analyzing part for analyzing the spectrum of the plasma received by the plasma receiving part; and a controller for determining the material of the work on the basis of a spectrum analysis signal from the spectrum analyzing part of the plasma detecting part and for controlling the laser beam irradiation unit.

### BACKGROUND OF THE INVENTION

1. Field of the Invention

The present invention relates to a laser beam machining apparatus for forming a laser beam machined hole in a work such as a semiconductor wafer.

2. Description of the Related Art

In the semiconductor device manufacturing process, a plurality of regions are demarcated in a face-side surface of a roughly circular disk-shaped semiconductor wafer by planned dividing lines called streets, and devices such as ICs and LSIs are formed in the thus demarcated regions. Then, the semiconductor wafer is cut along the streets so as to divide the regions provided therein with the devices, thereby manufacturing individual semiconductor chips.

In order to realize smaller apparatus sizes and higher functions, a module structure in which a plurality of devices are stacked and bonding pads provided on the stacked devices are connected has been put to practical use. The module structure has a configuration in which the semiconductor wafer is formed with through-holes (via holes) at locations where the bonding pads are provided, and the through-holes (via holes) are filled up with a conductive material such as aluminum for connection to the bonding pads (refer to, for example, Japanese Patent Laid-open No. 2003-163323).

The through-holes (via holes) provided in the semiconductor wafer as above-mentioned have been formed by a drill. However, the through-holes (via holes) formed in the semiconductor wafer has a diameter as small as 90 to 300 nm, and the formation of the holes (boring) by drilling is therefore low in productivity. In order to solve this problem, a boring method for a wafer has been proposed in which a wafer in which a plurality of devices are formed at the face-side surface of a substrate and bonding pads are formed on the devices is irradiated with a pulsed laser beam from the back side of the substrate, whereby via holes reaching the bonding pads are formed efficiently (refer to, for example, Japanese Patent Laid-open No. 2007-67082).

Meanwhile, in the case where the via holes reaching the bonding pads are formed by irradiation with a pulsed laser beam from the back side of the substrate, it is difficult to stop the irradiation with the pulsed laser beam at the time when the via holes formed in the substrate have just reached the bonding pads. As a result, there is the problem that the bonding pads may be melted, and holes may be formed in the bonding pads, under the irradiation with the pulsed laser beam.

### SUMMARY OF THE INVENTION

Accordingly, it is an object of the present invention to provide a laser beam machining apparatus with which via holes reaching bonding pads can be formed in a substrate of a wafer, without forming holes in the bonding pads.

In accordance with an aspect of the present invention, there is provided a laser beam machining apparatus includes a chuck table for holding a wafer; laser beam irradiation means for irradiating the wafer held on the chuck table with a pulsed laser beam; plasma detecting means which includes plasma receiving means for receiving the light of a plasma generated by irradiation of the work with the laser beam radiated from the laser beam irradiation means, and spectrum analyzing means for analyzing the spectrum of the plasma received by the plasma receiving means; and control means for determining the material of the work on the basis of a spectrum analysis signal from the spectrum analyzing means of the plasma detecting means and for controlling the laser beam irradiation means.

Preferably, the spectrum analyzing means includes a spectroscope by which the plasma light guided by the plasma receiving means is diffracted or separated into a spectrum, and a wavelength measuring instrument for measuring wavelengths of the spectrum obtained through diffraction by the spectroscope.

In addition, preferably, the spectrum analyzing means includes a spectroscope by which the plasma light guided by the plasma receiving means is diffracted into a spectrum, and a first photo-detector and a second photo-detector which are disposed respectively at positions of a first set wavelength and a second set wavelength in the spectrum obtained through diffraction by the spectroscope.

Furthermore, preferably, the spectrum analyzing means includes a beam splitter by which the plasma light guided by the plasma receiving means is split into a first optical path and a second optical path, a first band-pass filter disposed in the first optical path and permitting the light at a first set wavelength to pass therethrough, a first photo-detector for detecting the light having passed through the first band-pass filter, a second band-pass filter disposed in the second optical path and permitting the light at a second set wavelength to pass therethrough, and a second photo-detector for detecting the light having passed through the second band-pass filter.

In the laser beam machining apparatus according to the present invention, the plasma detecting means which includes the plasma receiving means for receiving a plasma generated by irradiation of a work with a pulsed laser beam from laser beam irradiation means and spectrum analyzing means for analyzing the spectrum of the plasma received by the plasma receiving means, and the control means which determines the material of the work on the basis of a spectrum analysis signal from the spectrum analyzing means of the plasma detecting means and controls the laser beam irradiation means, are provided. Therefore, for example in the case where the substrate of a wafer provided with bonding pads on the face side is irradiated with a laser beam from the back side so as to provided the substrate with laser beam-machined holes reaching the bonding pads, it is possible to detect that the laser beam-machined holes formed in the substrate have just reached the bonding pads, based on the spectrum analysis signal from the spectrum analyzing means. Therefore, the irradiation of the wafer with the laser beam can be stopped upon detection of the reaching of the laser beam-machined holes to the bonding pads, and, accordingly, the bonding pads can be prevented from melting with the result of formation of holes.

The above and other objects, features and advantages of the present invention and the manner of realizing them will become more apparent, and the invention itself will best be understood from a study of the following description and the appended claims with reference to the attached drawings showing some preferred embodiments of the invention.

### BRIEF DESCRIPTION OF THE DRAWINGS

FIG. 1 is a perspective view of a laser beam machining apparatus configured according to the present invention;

FIG. 2 is a block diagram of laser beam irradiation means with which the laser beam machining apparatus shown in FIG. 1 is equipped;

FIG. 3 is a block diagram of plasma receiving means with which the laser beam machining apparatus shown in FIG. 1 is equipped;

FIG. 4 is a block diagram showing another embodiment of spectrum analyzing means constituting the plasma receiving means shown in FIG. 3;

FIG. 5 is a block diagram showing a further embodiment of the spectrum analyzing means constituting the plasma receiving means shown in FIG. 3;

FIG. 6 is a plan view of a semiconductor wafer as a wafer;

FIG. 7 is a plan view showing, in an enlarged form, a part of the semiconductor wafer shown in FIG. 6;

FIG. 8 is a perspective view showing the condition where the semiconductor wafer shown in FIG. 6 is adhered to the surface of a protective tape attached to an annular frame;

FIG. 9 illustrates the relation of the semiconductor wafer shown in FIG. 6, in the state of being held at a predetermined position on a chuck table of the laser beam machining apparatus shown in FIG. 1, with coordinates;

FIGS. 10A and 10B illustrate a boring step carried out by use of the laser beam machining apparatus shown in FIG. 1; and

FIGS. 11A and 11B illustrate a boring step carried out by use of the laser beam machining apparatus shown in FIG. 1.

### DETAILED DESCRIPTION OF THE PREFERRED EMBODIMENTS

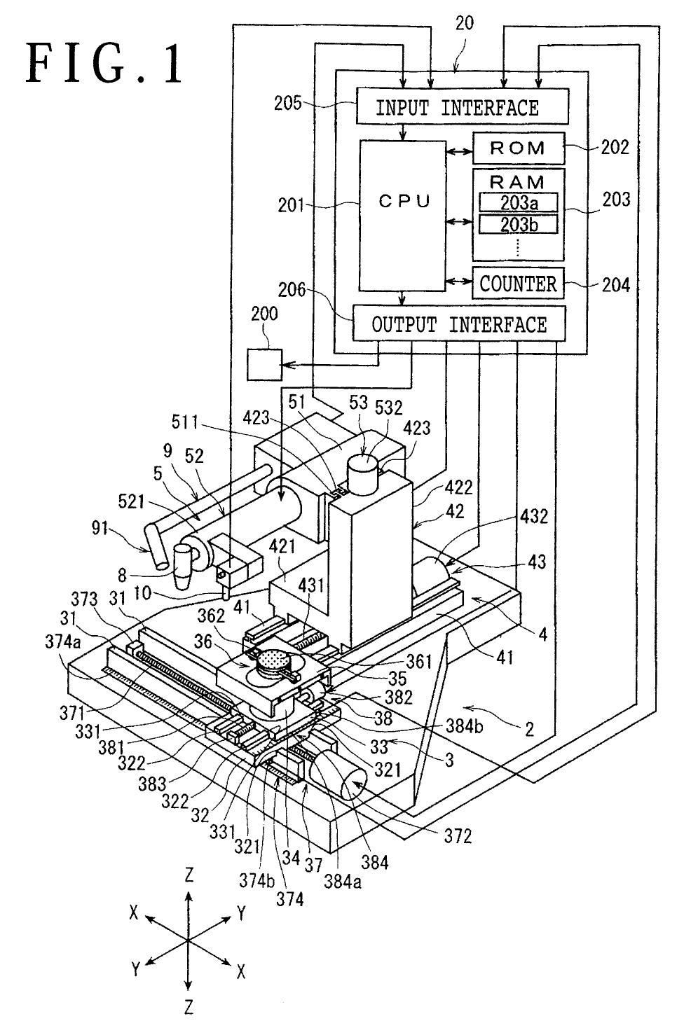

Now, a preferred embodiment of the laser beam machining apparatus configured according to the present invention will be described more in detail below, referring to the attached drawings. FIG. 1 shows a perspective view of a laser beam machining apparatus configured according to the present invention. The laser beam machining apparatus shown in FIG. 1 includes: a stationary base 2; a chuck table mechanism 3 for holding a work, disposed on the stationary base 2 so as to be movable in a machining feed direction indicated by arrow X (X-axis direction); a laser beam irradiation unit support mechanism 4 disposed on the stationary base 2 so as to be movable in an indexing feed direction indicated by arrow Y (Y-axis direction) orthogonal to the direction indicated by arrow X (X-axis direction); and a laser beam irradiation unit 5 disposed on the laser beam irradiation unit support mechanism 4 so as to be movable in a direction indicated by arrow Z (Z-axis direction).

The chuck table mechanism 3 includes: a pair of guide rails 31, 31 disposed on the stationary base 2 in parallel along the machining feed direction indicated by arrow X (X-axis direction); a first slide block 32 disposed on the guide rails 31, 31 so as to be movable in the machining feed direction indicated by arrow X (X-axis direction); a second slide block 33 disposed on the first slide block 32 so as to be movable in the indexing feed direction indicated by arrow Y (Y-axis direction); a cover table 35 supported on the second slide block 33 by a hollow cylindrical member 34; and a chuck table 36 as work holding means. The chuck table 36 has a suction chuck 361 formed from a porous material, and a work, for example, a circular disk-shaped semiconductor wafer is held on the suction chuck 361 by suction means (not shown). The chuck table 36 thus configured is rotated by a pulse motor (not shown) disposed inside the cylindrical member 34. Incidentally, the chuck table 36 is fitted with clamps 362 for fixing an annular frame which will be described later.

The first slide block 32 is provided in its lower surface with a pair of guided grooves 321, 321 in which to fit the pair of guide rails 31, 31, and is provided on its upper surface with a pair of guide rails 322, 322 formed in parallel along the indexing feed direction indicated by arrow Y (Y-axis direction). The first slide block 32 thus configured can be moved in the machining feed direction indicated by arrow X (X-axis direction) along the pair of guide rails 31, 31, with the guided grooves 321, 321 in engagement with the pair of guide rails 31, 31. The chuck table mechanism 3 in the embodiment shown in the figure has machining feeding means 37 for moving the first slide block 32 in the machining feed direction indicated by arrow X (X-axis direction) along the pair of guide rails 31, 31. The machining feeding means 37 includes a male screw rod 371 disposed between and in parallel to the pair of guide rails 31 and 31, and a drive source such as a pulse motor 372 for driving the male screw rod 371 to rotate. The male screw rod 371 is rotatably supported at its one end on a bearing block 373 fixed to the stationary base 2, and is power-transmittingly connected at its other end to an output shaft of the pulse motor 372. Incidentally, the male screw rod 371 is in screw engagement with a penetrating female screw hole formed in a female screw block (not shown) projectingly provided at a lower surface of a central part of the first slide block 32. Therefore, with the male screw rod 371 driven by the pulse motor 372 to rotate normally and reversely, the first slide block 32 is moved in the machining feed direction indicated by arrow X (X-axis direction) along the guide rails 31, 31.

The laser beam machining apparatus in the embodiment shown in the figure has X-axis direction position detecting means 374 for detecting the machining feed amount, or the position in the X-axis direction, of the chuck table 36. The X-axis direction position detecting means 374 includes a linear scale 374a disposed along the guide rail 31, and a reading head 374b which is disposed on the first slide block 32 and is moved along the linear scale 374a together with the first slide block 32. The reading head 374b of the X-axis direction position detecting means 374, in the embodiment shown in the figure, sends a pulse signal containing one pulse per 1 μm feed, to the control means which will be described later. Then, the control means described later counts the pulses contained in the pulse signal inputted thereto, to thereby detect the machining feed amount, or the position in the X-axis direction, of the chuck table 36.

Incidentally, in the case where the pulse motor 372 is used as the drive source of the machining feeding means 37, the machining feed amount, or the position in the X-axis direction, of the chuck table 36 can be detected also by counting driving pulses in the control means (described later) which outputs a driving signal to the pulse motor 372. Besides, in the case where a servo motor is used as the drive source of the machining feeding means 37, the machining feed amount, or the position in the X-axis direction, of the chuck table 36 can be detected also by a method in which a pulse signal outputted from a rotary encoder for detecting the rotating speed (the number of revolutions) of the servo motor is sent to the control means (described later) and the control means counts the pulses contained in the pulse signal inputted thereto.

The second slide block 33 is provided in its lower surface with a pair of guided grooves 331, 331 in which to fit the pair of guide rails 322, 322 provided on the upper surface of the first slide block 32, and can be moved in the indexing feed direction indicated by arrow Y (Y-axis direction), with its guided grooves 331, 331 in engagement with the pair of guide rails 322, 322. The chuck table 3 in the embodiment shown in the figure has first indexing feeding means 38 for moving the second slide block 33 in the indexing feed direction indicated by arrow Y (Y-axis direction) along the pair of guide rails 322, 322 provided on the first slide block 32. The first indexing feeding means 38 includes a male screw rod 381 disposed between and in parallel to the pair of guide rails 322 and 322, and a drive source such as a pulse motor 382 for driving the male screw rod 381 to rotate. The male screw rod 381 is rotatably supported at its one end on a bearing block 383 fixed to an upper surface of the first slide block 32, and is power-transmittingly connected at its other end to an output shaft of the pulse motor 382. Incidentally, the male screw rod 381 is in screw engagement with a penetrating female screw hole formed in a female screw block (not shown) projectingly provided at a lower surface of a central part of the second slide block 33. Therefore, with the male screw rod 381 driven by the pulse motor 382 to rotate normally and reversely, the second slide block 33 is moved in the indexing feed direction indicated by arrow Y (Y-axis direction) along the guide rails 322, 322.

The laser beam machining apparatus in the embodiment shown in the figure has Y-axis direction position detecting means 384 for detecting the indexing feed amount, or the position in the Y-axis direction, of the second slide block 33. The Y-axis direction position detecting means 384 includes a linear scale 384a disposed in parallel to the guide rail 322, and a reading head 384b which is disposed on the second slide block 33 and is moved along the linear scale 384a together with the second slide block 33. The reading head 384b of the Y-axis direction position detecting means 384, in the embodiment shown in the figure, sends a pulse signal containing one pulse per 1 μm feed, to the control means which will be described later. Then, the control means described later counts the pulses contained in the pulse signal inputted thereto, to thereby detect the indexing feed amount, or the position in the Y-axis direction, of the chuck table 36.

Incidentally, in the case where the pulse motor 382 is used as the drive source of the indexing feeding means 38, the indexing feed amount, or the position in the Y-axis direction, of the chuck table 36 can be detected also by counting driving pulses in the control means (described later) which outputs a driving signal to the pulse motor 382. Besides, in the case where a servo motor is used as the drive source of the first indexing feeding means 38, the indexing feed amount, or the position in the Y-axis direction, of the chuck table 36 can be detected also by a method in which a pulse signal outputted from a rotary encoder for detecting the rotating speed (the number of revolutions) of the servo motor is sent to the control means (described later) and the control means counts the pulses contained in the pulse signal inputted thereto.

The laser beam irradiation unit support mechanism 4 includes a pair of guide rails 41, 41 disposed in parallel along the indexing feed direction indicated by arrow Y (Y-axis direction), and a movable support base 42 disposed on the guide rails 41, 41 so as to be movable in the direction indicated by arrow Y. The movable support base 42 includes a moving support part 421 movably disposed on the guide rails 41, 41, and an attachment part 422 attached to the moving support part 421. The attachment part 422 is provided on its one side surface with a pair of guide rails 423, 423 which are parallel and extend in the direction indicated by arrow Z (Z-axis direction). The laser beam irradiation unit support mechanism 4 has second indexing feeding means 43 for moving the movable support base 42 in the indexing feed direction indicated by arrow Y (Y-axis direction) along the pair of guide rails 41, 41. The second indexing feeding means 43 includes a male screw rod 431 disposed between and in parallel to the pair of guide rails 41, 41, and a drive source such as a pulse motor 432 for driving the male screw rod 431 to rotate. The male screw rod 431 is rotatably supported at its one end on a bearing block (not shown) fixed to the stationary base 2, and is power-transmittingly connected at its other end to an output shaft of the pulse motor 432. Incidentally, the male screw rod 431 is in screw engagement with a female screw hole formed in a female screw block (not shown) projectingly provided at a lower surface of a central part of the moving support part 421 which constitute the movable support base 42. Therefore, with the male screw rod 431 driven by the pulse motor 432 to rotate normally and reversely, the movable support base 42 is moved in the indexing feed direction indicated by arrow Y (Y-axis direction) along the guide rails 41, 41.

The laser beam irradiation unit 5 includes a unit holder 51, and laser beam irradiation means 52 mounted to the unit holder 51. The unit holder 51 is provided with a pair of guided grooves 511, 511 in which to slidably fit the pair of guide rails 423, 423 provided on the attachment part 422, and is so supported as to be movable in the direction indicated by arrow Z (Z-axis direction), with its guided grooves 511, 511 in engagement with the guide rails 423, 423.

The laser beam irradiation unit 5 has moving means 53 for moving the unit holder 51 in the direction indicated by arrow Z (Z-axis direction) along the pair of guide rails 423, 423. The moving means 53 includes a male screw rod (not shown) disposed between the pair of guide rails 423, 423, and a drive source such as a pulse motor 532 for driving the male screw rod to rotate. With the male screw rod (not shown) driven by the pulse motor 532 to rotate normally and reversely, the unit holder 51 and the laser beam irradiation means 52 are moved in the direction indicated by arrow Z (Z-axis direction) along the guide rails 423, 423. Incidentally, in the embodiment shown in the figure, with the pulse motor 532 driven to rotate normally, the laser beam irradiation means 52 is moved upward, and, with the pulse motor 532 driven to rotate reversely, the laser beam irradiation means 52 is moved downward.

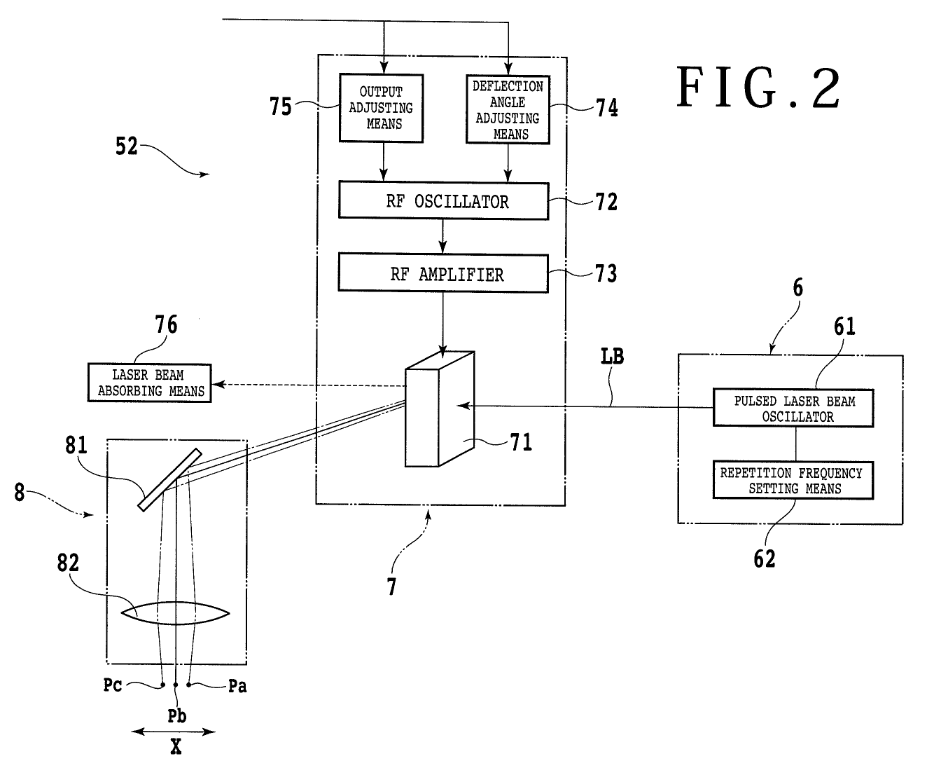

The laser beam irradiation means 52 includes a hollow cylindrical casing 521 disposed substantially horizontally, pulsed laser beam oscillating means 6 disposed inside the casing 521 as shown in FIG. 2, acousto-optical deflection means 7 by which a laser beam oscillated by the pulsed laser beam oscillation means 6 is deflected in the machining feed direction (X-axis direction), and a condenser 8 by which a work held on the chuck table 36 is irradiated with the pulsed laser beam having passed through the acousto-optical deflection means 7.

The pulsed laser beam oscillation means 6 includes a pulsed laser beam oscillator 61 composed of a YAG laser oscillator or a YVO4 laser oscillator, and repetition frequency setting means 62 annexed thereto. The pulsed laser beam oscillator 61 oscillates a pulsed laser beam (LB) with a predetermined frequency set by the repetition frequency setting means 62. The repetition frequency setting means 62 sets the repetition frequency of the pulsed laser beam oscillated by the pulsed laser beam oscillator 61.

The acousto-optical deflection means 7 includes: an acousto-optical element 71 by which the laser beam (LB) oscillated by the laser beam oscillating means 6 is deflected in the machining feed direction (X-axis direction); an RF oscillator 72 for generating an RF (radio frequency) wave to be applied to the acousto-optical element 71; an RF amplifier 73 for amplifying the power of the RF generated by the RF oscillator 72 and applying the amplified RF to the acousto-optical element 71; deflection angle adjusting means 74 for adjusting the frequency of the RF generated by the RF oscillator 72; and output adjusting means 75 for adjusting the amplitude of the RF generated by the RF oscillator 72. The acousto-optical element 71 can adjust the angle of deflection of the laser beam according to the frequency of the RF applied, and can adjust the output of the laser beam according to the amplitude of the RF applied.

Incidentally, the deflection angle adjusting means 74 and the output adjusting means 75 are controlled by the control means which will be described later.

In addition, the laser beam irradiation means 52 in the embodiment shown in the figure has laser beam absorbing means 76 for absorbing the laser beam deflected by the acousto-optical element 71 as indicated by broken line in FIG. 2 in the case where the RF with the predetermined frequency is applied to the acousto-optical element 71. The condenser 8 is mounted to the tip of the casing 521, and includes a direction change mirror 81 by which the direction of the pulsed laser beam deflected by the acousto-optical deflection means 7 is changed into a downward direction and a condenser lens 82 for condensing the laser beam of which the direction has been changed by the direction change mirror 81 is condensed.

The pulsed laser beam irradiation means 52 in the embodiment shown in the figures is configured as above-mentioned, and its operation will be described below referring to FIG. 2. In the case where a voltage of 5 V, for example, is applied to the deflection angle adjusting means 74 of the acousto-optical deflection means 7 from the control means (described later) and an RF with a frequency corresponding to 5 V is applied to the acousto-optical element 71, the pulsed laser beam oscillated from the pulsed laser beam oscillating means 6 is deflected as indicated by dot-dash line in FIG. 2, to be converged to a converging point Pa. In addition, in the case where a voltage of 10 V, for example, is applied to the deflection angle adjusting means 74 from the control means (described later) and an RF with a frequency corresponding to 10 V is applied to the acousto-optical element 71, the pulsed laser beam oscillated from the pulsed laser beam oscillating means 6 is deflected as indicated by solid line in FIG. 2, to be converged to a converging point Pb displaced from the converging point Pa by a predetermined amount to the left in FIG. 2 along the machining feed direction (X-axis direction).

On the other hand, in the case where a voltage of 15 V, for example, is applied to the deflection angle adjusting means 74 from the control means (described later) and an RF with a frequency corresponding to 15 V is applied to the acousto-optical element 71, the pulsed laser beam oscillated from the pulsed laser beam oscillating means 6 is deflected as indicated by two-dotted chain line in FIG. 2, to be converged to a converging point Pc displaced from the converging point Pb by a predetermined amount to the left side in FIG. 2 along the machining feed direction (X-axis direction). Furthermore, in the case where a voltage of 0 V, for example, is applied to the deflection angle adjusting means 74 of the acousto-optical deflection means 7 from the control means (described later) and an RF with a frequency corresponding to 0 V is applied to the acousto-optical element 71, the pulsed laser beam oscillated from the pulsed laser beam oscillating means 6 is guided to the laser beam absorbing means 76 as indicated by broken line in FIG. 2. Thus, the laser beam deflected by the acousto-optical element 71 is deflected in the machining feed direction (X-axis direction) correspondingly to the voltage applied to the deflection angle adjusting means 74.

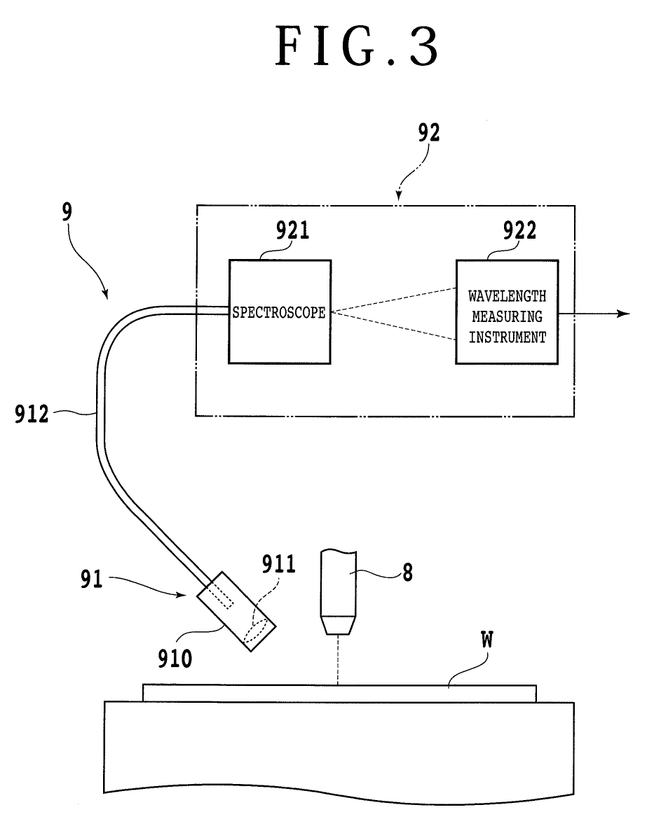

Returning to FIG. 1 to continue description, the laser beam machining apparatus in the embodiment shown in the figure has plasma detecting means 9 which is attached to the unit holder 51 of the laser beam irradiation unit 5 and which detects a plasma generated through irradiation of the work with the laser beam radiated from the laser beam irradiation means 52. As shown in FIG. 3, the plasma detecting means 9 includes plasma receiving means 91 for receiving the plasma generated by irradiation of the work with the laser beam radiated through the condenser 8 of the laser beam irradiation means 52, and spectrum analyzing means 92 for analyzing the spectrum of the plasma received by the plasma receiving means 91. The plasma receiving means 91 includes a lens case 910, a condenser lens 911 disposed inside the lens case 910, and an optical fiber 912 by which the plasma light condensed by the condenser lens 911 is guided to the spectrum analyzing means 92. The plasma receiving means 91 configured in this manner operates so that the plasma generated upon irradiation of the work W with the laser beam radiated through the condenser 8 of the laser beam irradiation means 52 is condensed by the condenser lens 911, and the plasma light condensed by the condenser lens 911 is guided through the optical fiber 912 to the spectrum analyzing means 92.

The spectrum analyzing means 92 includes a spectroscope 921 by which the plasma light guided by the optical fiber 912 is diffracted or separated into a spectrum, and a wavelength measuring instrument 922 for measuring the wavelengths of the spectrum obtained through diffraction or separation by the spectroscope 921. The wavelength measuring instrument 922, in the embodiment shown in the figure, is composed of a CCD line sensor, from which a voltage signal corresponding to the luminous intensity of the spectrum obtained through the diffraction is sent to the control means (described later). In the spectrum analyzing means 92 configured in this way, the plasma light guided by the optical fiber 912 is diffracted into a spectrum by the spectroscope 921. In the spectrum thus obtained through diffraction by the spectroscope 921, the spectrum of silicon has a wavelength of 386 nm, and the spectrum of aluminum has a wavelength of 395 nm. Incidentally, the relation between the material forming the work and the wavelength of the plasma is stored in a memory in the control means which will be described later. Therefore, the control means described later can judge that the work W being machined by the laser beam radiated through the condenser 8 of the laser beam irradiation means 52 is silicon when the wavelength of the spectrum measured by the wavelength measuring instrument 922 is around 386 nm. Similarly, the control means can judge that the work W being machined by the laser beam radiated through the condenser 8 of the laser beam irradiation means 52 is aluminum when the wavelength of the spectrum measured by the wavelength measuring instrument 922 is around 395 nm.

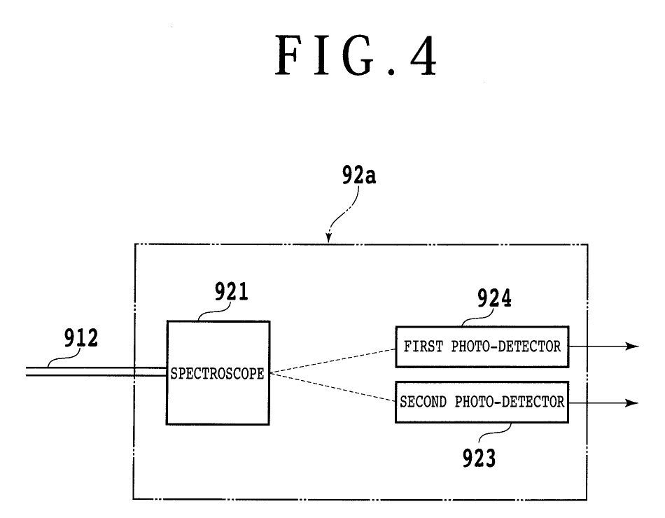

Now, another embodiment of the spectrum analyzing means will be described below, referring to FIG. 4. The spectrum analyzing means 92a shown in FIG. 4 includes a spectroscope 921 by which the plasma light guided by the optical fiber 912 is diffracted into a spectrum, and a first photo-detector 923 and a second photo-detector 924, wherein the first photo-detector 923 and the second photo-detector 924 send spectrum analysis signals to the control means which will be described later. The first photo-detector 923 is disposed at a position where the wavelength of the spectrum obtained through diffraction by the spectroscope 921 is 386 nm, for example, whereas the second photo-detector 924 is disposed at a position where the wavelength of the spectrum obtained through diffraction by the spectroscope 921 is 395 nm, for example. Therefore, the control means described later can judge that the work W being machined by the laser beam radiated through the condenser 8 of the laser beam irradiation means 52 is silicon when the spectrum analysis signal is inputted thereto from the first photo-detector 923. Similarly, the control means can judge that the work W being machined by the laser beam radiated through the condenser 8 of the laser beam irradiation means 52 is aluminum when the spectrum analysis signal is inputted thereto from the second photo-detector 924.

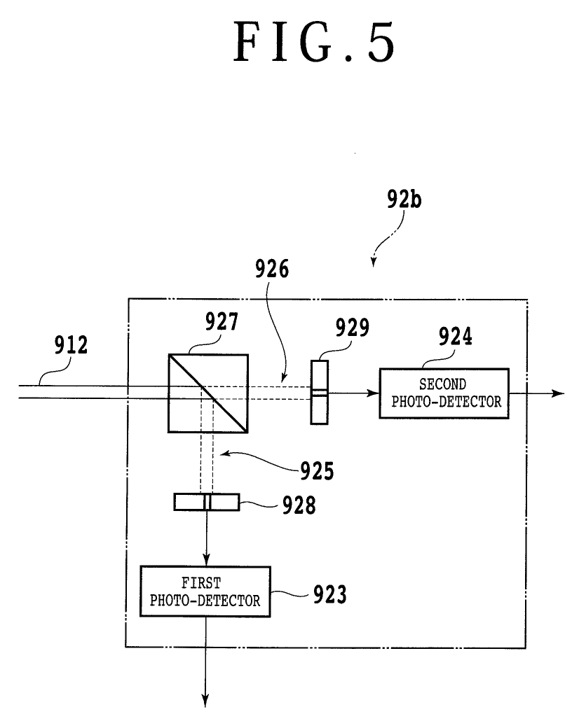

Now, a further embodiment of the spectrum analyzing means will be described below, referring to FIG. 5. The spectrum analyzing means 924b shown in FIG. 5 includes: a beam splitter 927 by which the plasma light guided by the optical fiber 912 is split into a first optical path 925 and a second optical path 926; a first band-pass filter 928 which is disposed in the first optical path 925 and permits the light with a first set wavelength of 386 nm, for example, to pass therethrough; a first photo-detector 923 for detecting the light having passed through the first band-pass filter 928; a second band-pass filter 929 which is disposed in the second optical path 926 and permits the light with a second set wavelength of 395 nm, for example, to pass therethrough; and a second photo-detector 924 for detecting the light having passed through the second band-pass filter 929. The first photo-detector 923 and the second photo-detector 924 send spectrum analysis signals to the control means which will be described later. The spectrum analyzing means 92b configured in this manner operates so that, of the plasma light guided by the optical fiber 912, only the light with a wavelength of 386 nm passes through the first band-pass filter 928 to be detected by the first photo-detector 923 and that, of the plasma light guided by the optical fiber 922, only the light with a wavelength of 395 nm passes through the second band-pass filter 929 to be detected by the second photo-detector 924. Therefore, the control means described later can judge that the work W being machined by the laser beam radiated through the condenser 8 of the laser beam irradiation means 52 is silicon when the spectrum analysis signal is inputted thereto from the first photo-detector 923. Similarly, the control means can judge that the work W being machined by the laser beam radiated through the condenser 8 of the laser beam irradiation means 52 is aluminum when the spectrum analysis signal is inputted thereto from the second photo-detector 924.

Returning to FIG. 1 to continue description, the laser beam machining apparatus in the embodiment shown in the figure has image pickup means 10 which is disposed at a front end part of the casing 521 and which picks up an image of a machining region where to perform laser beam machining by the laser beam irradiation means 52. The image pickup means 10 includes, in addition to an ordinary image pickup element (CCD) for picking up images by use of visible rays, infrared irradiation means for irradiating the work with infrared rays, an optical system for catching the infrared rays radiated by the infrared irradiation means, an image pickup element (infrared CCD) for outputting an electrical signal corresponding to the infrared rays caught by the optical system, etc., and sends a picture signal of the image picked up to the control means which will be described later.

Returning to FIG. 1 to continue description, the laser beam machining apparatus in the embodiment shown in the figure has control means 20. The control means 20 is configured by use of a computer, which includes a central processing unit (CPU) 201 for executing arithmetic operations according to a control program, a read only memory (ROM) 202 for storing the control program and the like, a readable/writable random access memory (RAM) 203 for storing a control map (described later), design value data on the work, the results of arithmetic operations, etc., a counter 204, an input interface 205 and an output interface 206. The input interface 205 of the control means 20 is supplied as inputs with detection signals from the X-axis direction position detecting means 374, the Y-axis direction position detecting means 384, the spectrum analyzing means 92 (92a, 92b), the image pickup means 10, and so on. On the other hand, control signals are outputted from the output interface 206 of the control means 20 to the pulse motor 372, the pulse motor 382, the pulse motor 432, the pulse motor 532, the pulsed laser beam irradiation means 52, display means 200, and so on. Incidentally, the random access memory (RAM) 203 has a first storage region 203a for storing the relationship between the material forming the work and the wavelength of plasma, a second storage region 203b for storing the design value data on the wafer which will be described later, and other storage regions.

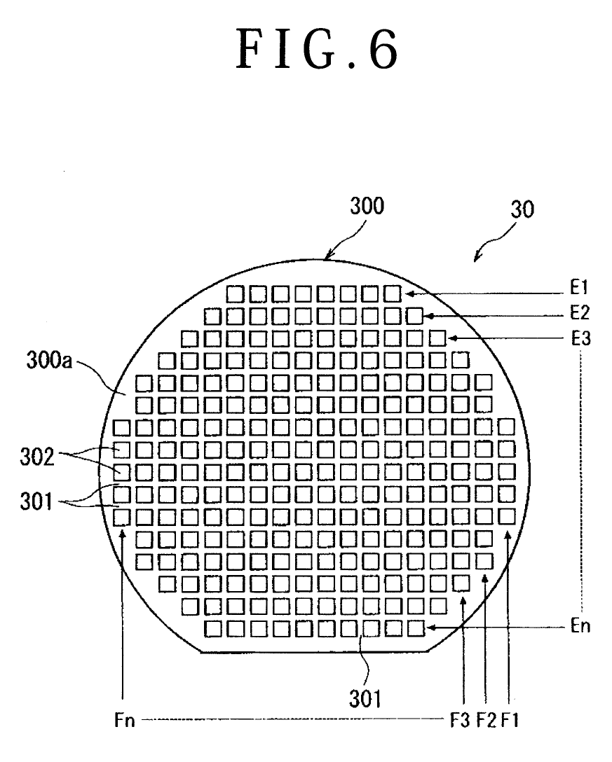

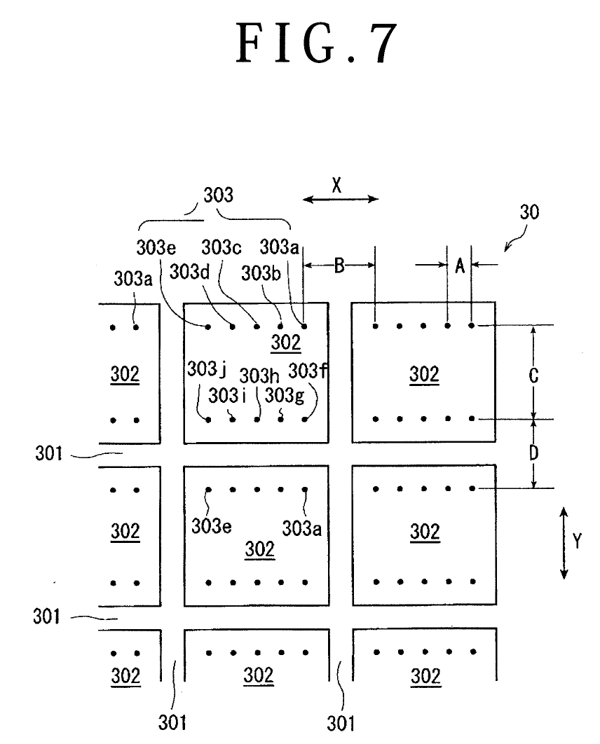

The laser beam machining apparatus in the embodiment shown in the figures is configured as above-mentioned, and its operation will be described below. FIG. 6 shows a plan view of a semiconductor wafer 30 as a work to be subjected to laser beam machining. The semiconductor wafer 30 shown in FIG. 6 has a plurality of regions demarcated by a plurality of planned dividing lines 301 arranged in a grid pattern in a face-side surface 300a of a silicon substrate 300, and devices 302 such as ICs and LSIs are formed in the thus demarcated regions. All the devices 302 are the same in configuration. A plurality of bonding pads 303 (303a to 303j) are formed on the surface of each device 302, as shown in FIG. 7. The bonding pads 303 (303a to 303j), in the embodiment shown in the figures, are formed from aluminum. Incidentally, in the embodiment shown in the figures, the bonding pads 303a and 303f, the bonding pads 303b and 303g, the bonding pads 303c and 303h, the bonding pads 303d and 303i, and the bonding pads 303e and 303j, are respectively the same in position in the X-axis direction. The plurality of bonding pad 303 (303a to 303j) parts are provided with machined holes (via holes) reaching the bonding pads 303, from a back-side surface 300b. The intervals A in the X-direction (the left-right direction in FIG. 7) of the bonding pads 303 (303a to 303j) on each device 302, and the intervals B between the bonding pads, adjacent to each other in the X-direction (the left-right direction in FIG. 7) with the planned dividing line 301 therebetween, of the bonding pads 303 formed on the devices 302, namely, between the bonding pad 303e and the bonding pad 303a, are set to be respectively equal in the embodiment shown in the figures.

In addition, the intervals C in the Y-direction (the vertical direction in FIG. 7) of the bonding pads 303 (303a to 303j) on each device 302, and the intervals D between the bonding pads, adjacent to each other with the planned dividing line 301 therebetween, of the bonding pads 303 formed on the devices 302, namely, between the bonding pad 303f and the bonding pad 303a and between the bonding pad 303j and the bonding pad 303e, are set to be respectively equal in the embodiment shown in the figures. The design value data on the number of the devices 302 arrayed in each of rows E1 . . . En and each of columns F1 . . . Fn shown in FIG. 6 as well as the intervals A, B, C, D and the X and Y coordinates of the devices 302, in regard of the semiconductor wafer 30 configured as above-mentioned, are stored in the second storage region 203b of the random access memory (RAM) 203.

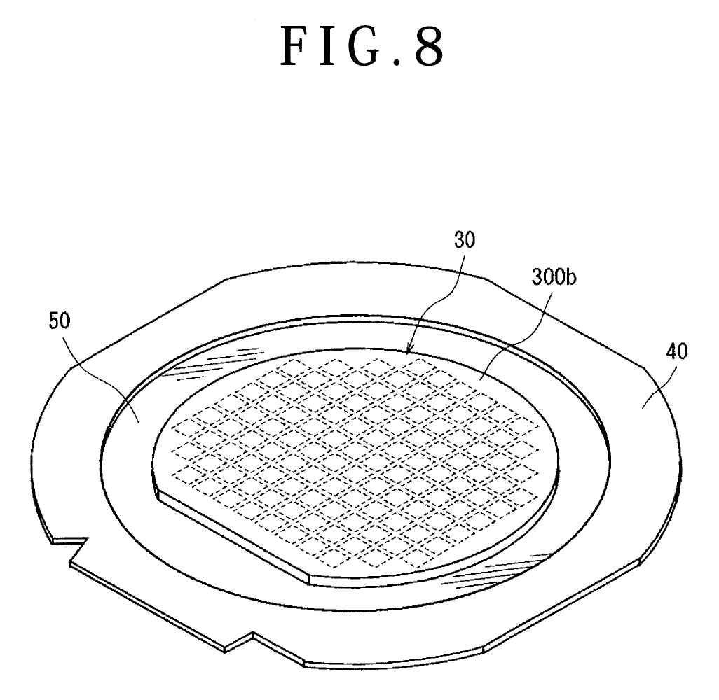

An embodiment of laser beam machining for forming laser beam machined holes (via holes) in the bonding pad 303 (303a to 303j) parts of each of the devices 302 formed in the semiconductor wafer 30 by use of the above-described laser beam machining apparatus will now be described below. As shown in FIG. 8, the face-side surface 300a of the semiconductor wafer 30 is adhered to a protective tape 50 composed of a sheet of a synthetic resin such as polyolefin, which is attached to an annular frame 40. Therefore, the back-side surface 300b of the semiconductor wafer 30 is the upper side. Of the semiconductor wafer 30 thus supported by the annular frame 40 through the protective tape 50, the protective tape 50 side is mounted on the chuck table 36 of the laser beam machining apparatus shown in FIG. 1. Then, suction means (not shown) is operated, whereby the semiconductor wafer 30 is held by suction on the chuck table 36 through the protective tape 50 therebetween. Therefore, the semiconductor wafer 30 is held, with its back-side surface 300b on the upper side. Besides, the annular frame 40 is fixed by the clamps 362.

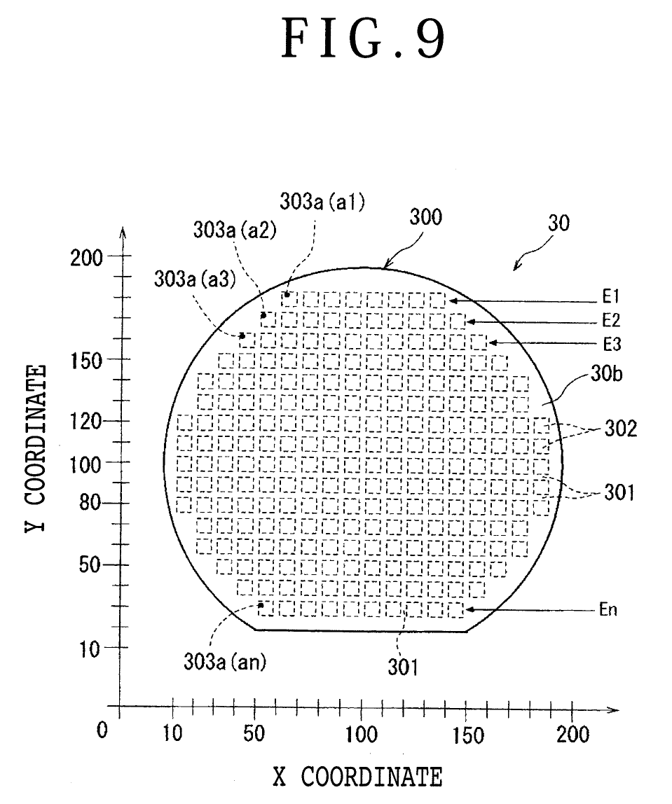

The chuck table 36 with the semiconductor wafer 30 held thereon by suction as above-mentioned is positioned into a position just under the image pickup means 10 by the machining feeding means 37. With the chuck table 36 positioned in the position just under the image pickup means 10, the semiconductor wafer 30 on the chuck table 36 is positioned at the coordinate position shown in FIG. 9. In this condition, an alignment work is carried out to check whether the planned dividing lines 301 formed in a grid pattern in the semiconductor wafer 30 held on the chuck table 36 are disposed in parallel to the X-axis direction and the Y-axis direction, respectively. Specifically, an image of the semiconductor wafer 30 held on the chuck table 36 is picked up by the image pickup means 10, and image processing such as pattern matching is carried out so as to perform the alignment work. In this case, the face-side surface 300a provided with the planned dividing lines 301 of the semiconductor wafer 30 is located on the lower side. However, since the image pickup means 10 has the image pickup means including the infrared irradiation means and the optical system for catching the infrared rays as well as the image pickup element (infrared CCD) for outputting an electrical signal corresponding to the infrared rays thus caught, etc. as described above, an image of the planned dividing lines 301 can be picked up on the side of the back-side surface 300b of the semiconductor wafer 30 in a see-through manner.

Next, the chuck table 36 is moved so that the device 302 at the leftmost end in FIG. 9 of the uppermost line E1, of the devices 302 formed in the semiconductor wafer 30, is positioned into the position just under the image pickup means 10. Then, further, the electrode 303a at the left upper position in FIG. 9, of the electrodes 303 (303a to 303j) formed on the device 302, is positioned into the position just under the image pickup means 10. After the electrode 303a is detected by the image pickup means 10 in this condition, its coordinate value (a1) is sent to the control means 20 as a first machining feed starting position coordinate value. Then, the control means 20 stores this coordinate value (a1) into the random access memory (RAM) 203 as the first machining feed starting position coordinate value (machining feed starting position detecting step). In this instance, since the image pickup means 10 and the condenser 8 of the laser beam irradiation means 52 are disposed at a predetermined interval in the X-axis direction, the X coordinate value to be stored is obtained by adding the interval between the image pickup means 10 and the condenser 8.

After the first machining feed starting position coordinate value (a1) of the device 302 in the uppermost line E1 in FIG. 9 is detected in this manner, the chuck table 36 is subjected to an indexing feed in the Y-axis direction by the interval of the planned dividing lines 301, and is moved in the X-axis direction, whereby the device 302 at the leftmost end in the second uppermost line E2 in FIG. 9 is positioned into the position just under the image pickup means 10. Then, further, the electrode 303a at the left upper position in FIG. 7, of the electrodes 303 (303a to 303j) formed on the device 302, is positioned into the position just under the image pickup means 10. After the electrode 303a is detected by the image pickup means 10 in this condition, its coordinate (a2) is sent to the control means 20 as a second machining feed starting position coordinate value. Then, the control means 20 stores this coordinate value (a2) into the random access memory (RAM) 203 as the second machining feed starting position coordinate value. In this instance, the image pickup means 10 and the condenser 8 of the laser beam irradiation means 52 are disposed at a predetermined interval in the X-axis direction as described above, the X-axis coordinate to be stored is obtained by adding the interval between the image pickup means 10 and the condenser 8. Thereafter, the control means 20 repeats the indexing feed and the machining feed starting position detecting step until the lowermost line En in FIG. 9 is treated in this way, so as to detect the machining feed starting position coordinate values (a3 to an) for the devices 302 formed in the lines, and stores the coordinate values into the random access memory (RAM) 203.

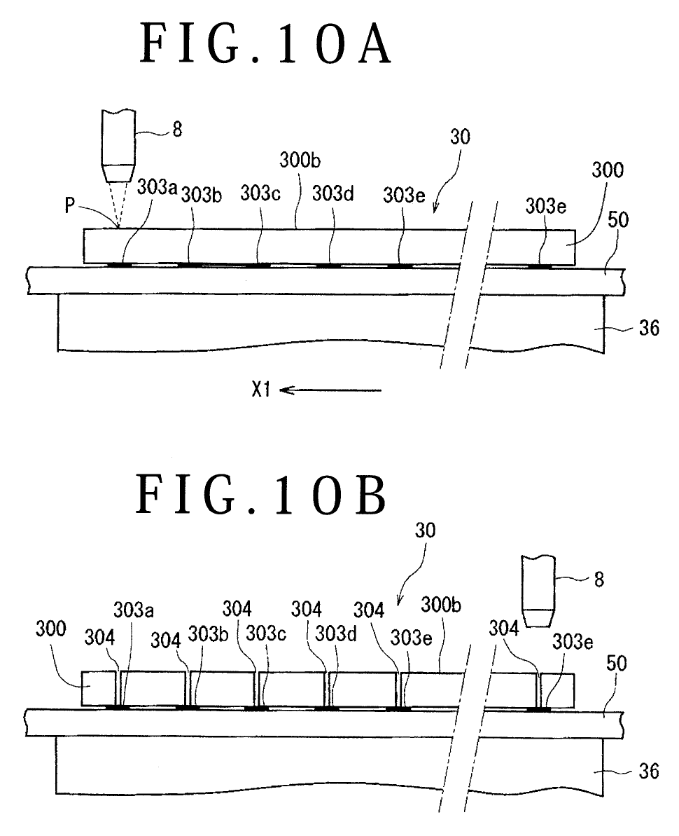

Next, a boring step is carried out in which laser beam-machined holes (via holes) are bored in the each electrode 303 (303a to 303j) parts of each of the devices 302 of the semiconductor wafer 30. In carrying out the boring step, first, the machining feeding means 37 is operated to move the chuck table 36, whereby a wafer portion corresponding to the first machining feed starting position coordinate value (a1) stored in the random access memory (RAM) 203 is positioned into the position just under the condenser 8 of the laser beam irradiation means 52. The condition where the wafer portion corresponding to the first machining feed starting position coordinate value (a1) is thus positioned into the position just under the condenser 8 in this manner is shown in FIG. 10A. Starting from the condition shown in FIG. 10A, the control means 20 controls the machining feeding means 37 so as to perform a machining feed of the chuck table 36 at a predetermined moving speed in the direction indicated by arrow X1 in FIG. 10A, and, simultaneously, operates the laser beam irradiation means 52 to radiate a pulsed laser beam through the condenser 8. Incidentally, the converging point P of the pulsed laser beam radiated through the condenser 8 is adjusted to a point in the vicinity of the face-side surface 30a of the semiconductor wafer 30. In this case, the control means 20 outputs control signals for controlling the deflection angle adjusting means 74 and the output adjusting means 75 of the acousto-optical deflection means 7, based on the detection signals from the reading head 374b of the machining feed amount detecting means 374.

On the other hand, the RF oscillator 72 outputs an RF corresponding to control signals from the deflection angle adjusting means 74 and the output adjusting means 75. The power of the RF outputted from the RF oscillator 72 is amplified by the RF amplifier 73, and the amplified RF is applied to the acousto-optical element 71. As a result, the acousto-optical element 71 deflects the pulsed laser beam, oscillated from the pulsed laser beam oscillating means 6, from the position indicated by dot-dash line to the position indicated by two-dotted chain line in FIG. 2, and adjusts the output of the pulsed laser beam oscillated from the pulsed laser beam oscillating means 6. Consequently, the wafer portion corresponding to the first machining feed starting position coordinate value (a1) can be irradiated with the pulsed laser beam of a predetermined output.

An example of the machining conditions for the boring step will now be described.

Light source: LD-excited Q switch Nd: YVO4

Wavelength: 355 nm

Repetition frequency: 2 kHz

Pulse energy: 0.1 mJ

Converging spot diameter: φ10 μm

While the boring step is carried out, the control means 20 operates the plasma detecting means 9 and is supplied with a detection signal from the spectrum analyzing means 92 (92a, 92b). Where the spectrum analyzing means is the spectrum analyzing means 92 shown in FIG. 3, if the wavelength of the spectrum measured by the wavelength measuring instrument 922 is 386 nm, the control means 20 determines that the silicon substrate 300 is being machined, and continues the boring step. On the other hand, if the wavelength of the spectrum measured by the wavelength measuring instrument 922 has become 395 nm, the control means 20 determines that the bonding pad 303 formed of aluminum has been machined; in this case, the control means 20 applies a voltage of 0 V to the deflection angle adjusting means 74 of the acousto-optical deflection means 7, and applies an RF with a frequency corresponding to 0 V to the acousto-optical element 71, whereby the pulsed laser beam oscillated from the pulsed laser beam oscillating means 6 is guided to the laser beam absorbing means 76 as indicated by broken line in FIG. 2. Therefore, the pulsed laser beam is not radiated to the semiconductor wafer 30 held on the chuck table 36. Thus, upon irradiation of the bonding pad 303 with one pulse of laser beam, it is detected by the spectrum analyzing means 92 of the plasma detecting means 9 that the bonding pad 303 has been machined, and the irradiation of the bonding pad 303 with the pulsed laser beam is stopped, and, therefore, the bonding pad 303 is prevented from melting with the result of formation of a hole. Consequently, the silicon substrate 300 of the semiconductor wafer 30 can be provided with machined holes 304 reaching the bonding pads 303, as shown in FIG. 10B.

Incidentally, in the case where the spectrum analyzing means is the spectrum analyzing means 92a or the spectrum analyzing means 92b indicated respectively in FIG. 4 or 5, if a spectrum analysis signal from the first photo-detector 923 of the spectrum analyzing means 92a or the spectrum analyzing means 92b is inputted to the control means 20, the control means 20 determines that the silicon substrate 300 is being machined, and continues the boring step. On the other hand, if a spectrum analysis signal from the second photo-detector 924 is inputted, the control means 20 determines that the bonding pad 303 formed of aluminum has been machined; then applies a voltage of 0 V to the deflection angle adjusting means 74 of the acousto-optical deflection means 7, and applies an RF with a frequency corresponding to 0 V to the acousto-optical element 71, whereby the pulsed laser beam oscillated from the pulsed laser beam oscillating means 6 is guided to the laser beam absorbing means 76 as indicated by broken line in FIG. 2. Therefore, the pulsed laser beam is not radiated to the semiconductor wafer 30 held on the chuck table 36.

On the other hand, the control means 20 is being supplied with a detection signal from the reading head 374b of the X-axis direction position detecting means 374, and is counting the pulses contained in the detection signal by a counter 204. When the count obtained by the counter 204 has reached the coordinate value of the next bonding pad 303, the control means 20 controls the laser beam irradiation means 52 to perform the boring step. Thereafter, also, each time the count obtained by the counter 204 has reached the coordinate value of the bonding pad 303, the control means 20 operates the laser beam irradiation means 52 to carry out the boring step. After the boring step is carried out at the position of the electrode 303e at the rightmost end in FIG. 10B, of the bonding pads 303 formed on the device 302 at the rightmost end in line E1 of the semiconductor wafer 30 as shown in FIG. 10B, the operation of the machining feeding means 37 is stopped, whereby the movement of the chuck table 36 is stopped. As a result, the silicon substrate 300 of the semiconductor wafer 30 is provided with the laser beam-machined holes 304 reaching the bonding pads 303, as shown in FIG. 10B.

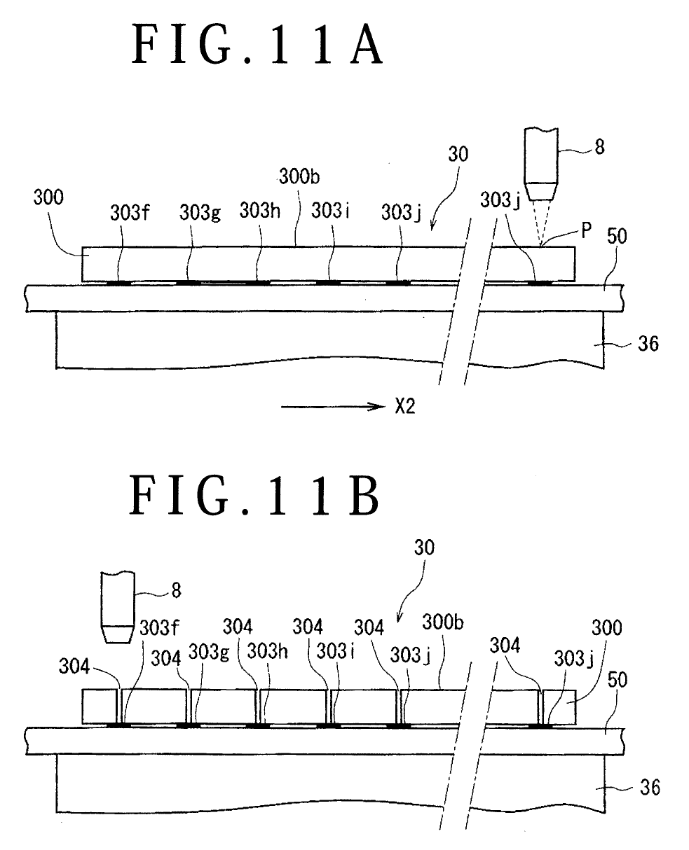

Next, the control means 20 controls the first indexing feeding means 38 so as to perform an indexing feed of the condenser 8 of the laser beam irradiation means 52 in the direction orthogonal to the surface of sheet in FIG. 10B. On the other hand, the control means 20 is being supplied with a detection signal from the reading head 384b of the Y-axis direction position detecting means 384, and is counting the pulses contained in the detection signal by a counter 204. When the count obtained by the counter 204 has reached a value corresponding to the interval C of the bonding pads 303 in the Y-axis direction in FIG. 7, the operation of the first indexing feeding means 38 is stopped, whereby the indexing feed of the condenser 8 of the laser beam irradiation means 52 is stopped. Consequently, the condenser 8 is positioned in the position just above the electrode 303j (see FIG. 7) opposed to the bonding pad 303e. This condition is shown in FIG. 11A.

Under the condition shown in FIG. 11A, the control means 20 controls the machining feeding means 37 so as to perform a machining feed of the chuck table 36 at a predetermined moving speed in the direction indicated by arrow X2 in FIG. 11A, and, simultaneously, operates the laser beam irradiation means 52 to carry out the boring step. Then, the control means 20 counts the pulses contained in the detection signal from the reading head 374b of the X-axis direction position detecting means 374 by the counter 204 as above-mentioned, and, each time the count has reached a value corresponding to the bonding pad 303, the control means 20 operates the laser beam irradiation means 52 to perform the boring step. After the boring step is carried out at the position of the bonding pad 303f formed on the device 302 at the rightmost end in line E1 of the semiconductor wafer 30 as shown in FIG. 11B, the operation of the machining feeding means 37 is stopped, whereby the movement of the chuck table 36 is stopped. Consequently, the silicon substrate 300 of the semiconductor wafer 30 is provided with the laser beam-machined holes 304 on the back side of the bonding pads 303 as shown in FIG. 11B.

After the laser beam-machined holes 304 are formed on the back side of the electrodes 303 formed on the devices 302 in line E1 of the semiconductor wafer 30 in the above-mentioned manner, the control means 20 operates the machining feeding means 37 and the first indexing feeding means 38 so that the portion, corresponding to the second machining feed starting position coordinate value (a2) stored in the random access memory (RAM) 203, of the bonding pads 303 formed on the devices 302 in line E2 of the semiconductor wafer 30 is positioned into the position just under the condenser 8 of the laser beam irradiation means 52. Then, the control means 20 controls the laser beam irradiation means 52 as well as the machining feeding means 37 and the first indexing feeding means 38 so as to perform the boring step on the back side of the bonding pads 303 formed on the devices 302 in line E2 of the semiconductor wafer 30. Thereafter, the boring step is conducted also on the back side of the bonding pads 303 formed on the devices 302 in lines E3 to En of the semiconductor wafer 30. As a result, the silicon substrate 300 of the semiconductor wafer 30 is provided with the laser beam-machined holes 304 on the back side of the bonding pads 303 formed on each of the devices 302.

Incidentally, in the boring step, the irradiation of the semiconductor wafer 30 with the pulsed laser beam is invalidated for the interval a regions and the interval B regions in the X-axis direction in FIG. 7 and for the interval C regions and the interval D regions in the Y-axis direction in FIG. 7. In order to invalidate the irradiation of the semiconductor wafer 30 with the pulsed laser beam in this manner, the control means 20 applies a voltage of 0 V to the deflection angle adjusting means 74 of the acousto-optical deflection means 7. As a result, an RF with a frequency corresponding to 0 V is applied to the acousto-optical element 71, whereby the pulsed laser beam (LB) oscillated from the pulsed laser beam oscillating means 6 is guided to the laser beam absorbing means 76 as indicated by broken line in FIG. 2, so that the semiconductor wafer 30 is not irradiated with the pulsed laser beam.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser beam machining apparatus comprising:
a chuck table for holding a wafer;
laser beam irradiation means for irradiating said wafer held on said chuck table with a pulsed laser beam;
plasma detecting means which includes plasma receiving means for receiving the light of a plasma generated by irradiation of the work with said laser beam radiated from said laser beam irradiation means, and spectrum analyzing means for analyzing said plasma received by said plasma receiving means; and
control means for determining the material of said work on the basis of a spectrum analysis signal from said spectrum analyzing means of said plasma detecting means and for controlling said laser beam irradiation means.

2. The laser beam machining apparatus as set forth in claim 1, wherein said spectrum analyzing means includes a spectroscope by which the plasma light guided by said plasma receiving means is diffracted into a spectrum, and a wavelength measuring instrument for measuring wavelengths of the spectrum obtained through diffraction by said spectroscope.

3. The laser beam machining apparatus as set forth in claim 1, wherein said spectrum analyzing means includes a spectroscope by which the plasma light guided by said plasma receiving means is diffracted into a spectrum, and a first photo-detector and a second photo-detector which are disposed respectively at positions of a first set wavelength and a second set wavelength in the spectrum obtained through diffraction by said spectroscope.

4. The laser beam machining apparatus as set forth in claim 1, wherein said spectrum analyzing means includes a beam splitter by which the plasma light guided by said plasma receiving means is split into a first optical path and a second optical path, a first band-pass filter disposed in said first optical path and permitting the light at a first set wavelength to pass therethrough, a first photo-detector for detecting the light having passed through said first band-pass filter, a second band-pass filter disposed in said second optical path and permitting the light at a second set wavelength to pass therethrough, and a second photo-detector for detecting the light having passed through said second band-pass filter.
